(19) United States
(12) Patent Application Publication
(10) Pub. No.: US 2015/0020910 A1
(43) Pub. Date: Jan. 22, 2015

(54) BEND LIMITER

(71) Applicant: National Oilwell Varco Denmark I/S, Brondby (DK)

(72) Inventor: Bjarke Pedersen, Hillerod (DK)

(21) Appl. No.: 14/375,505

(22) PCT Filed: Jan. 16, 2013
(86) PCT No.: PCT/DK2013/050013

§ 371 Date: Jul. 30, 2014

(30) Foreign Application Priority Data
Feb. 2, 2012 (DK) PA 2012 00092

(51) Int. Cl. F16L 35/00; F16L 57/02; E21B 17/01

(52) U.S. Cl. CPC F16L 35/00; E21B 17/017; F16L 57/02
USPC 138/106

(57) ABSTRACT

The present invention concerns a bend limiter suitable for protecting a flexible pipe against over bending. The bend limiter has a length extending between a first end and a second end and a hollow bore along its length. The hollow bore is defined by a surrounding bend limiter wall. The hollow bore has a centre line along the length of the bend limiter wherein
the centre line of the hollow bore, when the bend limiter is in an unloaded condition, is a curved centre line or
the centre line of the bore, when the bend limiter is in an unloaded condition, is a straight centre line and the bend limiter wall is at most two fold rotational symmetrical around the straight centre line.

### TECHNICAL FIELD

The present invention relates to a bend limiter suitable for protecting a flexible pipe, such as a flexible pipe for offshore applications.

### BACKGROUND ART

Bend limiters for use in combination with flexible pipes are well known in the art and cover both “bend stiffeners” and “bend restrictors”.

The term “bend limiter” is herein used to cover both bend stiffener and bend restrictors.

A bend limiter has the function of stiffening a flexible pipe in a selected section of the flexible pipe. The bend limiter is provided to prevent overbending of the flexible pipe, i.e. the bend limiter has the purpose of restricting or reducing the risk of bending the flexible pipe beyond a maximal bending radius.

Flexible pipes and structures are for example used in the oil industry for raising or transporting hydrocarbons from a subsea well head to a platform or floating equipment such as a Floating Production and Storage Offloading boat known by the abbreviation FPSO. Such flexible pipes are for example described in “Recommended Practice for Flexible Pipe “API Recommended Practice 17 B”, fourth edition 2008 published by the American Petroleum Industry. A bend limiter is in particular useful in combination with an unbonded flexible pipe e.g. as described in “Specification for unbonded flexible pipe” API 17J, third edition 2008, also published by the American Petroleum Industry.

It should be observed that bend limiters, inclusive the bend limiter of the present invention can also be used with other types of flexible pipelines, particularly in the case of subsea oil extraction installations, such as multi-pipe flexible lines known as umbilicals or electrical cables.

A flexible pipe has at least two main benefits compared to stiff pipes, namely that it can be transported in long lengths on a reel and that it can move and adapt to quite substantial forces to which it may be subjected during use e.g. subsea use. However, even though the flexible pipe can be quite flexible as long as it is not bent beyond a certain bending radius, a bend beyond a minimum bending radius (MBR) for a given flexible pipe may potentially damage the pipe even to a degree of burst or collapse of the pipe. If the flexible pipe is intended for use in transferring of hydrocarbon, e.g. raw oils, such damaging of the flexible pipe may have catastrophical consequences and it is therefore important to ensure or minimize the risk of any potential overbending beyond the MBR of a given pipe.

Flexible pipes are often installed as either stationary pipes, i.e. the pipes positioned as flow lines along a seabed, or as dynamic pipes, i.e. the pipes which are used are subjected to various forces and deformations and especially forces which may lead to substantial bends of the flexible pipe. A pipe installed to be a dynamic pipe is for example a riser or a pipe connected to a floating units (platform, vessels and other). For a pipe installed to be a stationary pipe e.g. a flow line, a risk of overbending is mainly present near connection(s) between the flexible pipe and other equipments, and often such risk of overbending stationary flexible pipes is relatively low depending on the whole structure in which the flexible pipe is connected. Risk of overbending flexible pipes for stationary use is mainly present during the installation of the flexible pipe.

For dynamic use the risk of overbending a flexible pipe is much higher and it is much more common to use bend limiters for avoiding overbending of such flexible pipes.

A bend limiter may for example be fitted in the region where the flexible pipe is joined to an end fitting or fittings. The term “end fitting” is used herein as a generic term to comprise end-fittings which are fitted to the flexible pipe at its two ends, a termination member (or end termination), as well as an end-connector used for connecting the flexible pipe to another element, such as another pipe, a subsea well head, a vessel or a platform.

A stiffener may also be mounted on a length section of the flexible pipe some distance from the end fittings, for example at the edge of an intermediate support, for example in the case of a flexible pipe being used as a riser with a “lazy S” or “Steep S” configuration, as described in API 17 B, or alternatively, at the end of a rigid guide tube protecting the upper part of the flexible pipe, as depicted in FIGS. 11, 12 and 13 of WO 92/12376 or in EP-565,445.

The prior art limiters may for example consist of a single elastic body moulded in polyurethane and may alternatively comprise an internal reinforcing structure as described in WO 92/12376 or in GB-A-2,291,686. They may also comprise heat-dissipation means, as is recommended in GB-A-2,291,686.

The prior art bend limiters are generally constructed to have full rotational symmetryl mechanical characteristics, in order to prevent overbending of the flexible pipe irrespective of the direction of bending of the pipe.

The object of the present invention is to provide an alternative bend limiter.

### DISCLOSURE OF INVENTION

This object has been achieved by the present invention as defined in the claims.

The bend limiter of the invention and embodiments thereof have shown to have a large number of advantages which will be clear from the following description.

The bend limiter of the invention is suitable for protecting a flexible pipe, such as the flexible pipe described above e.g. a bonded flexible pipe or an unbonded flexible pipe for use in the oil industry, and in particular for offshore applications.

Flexible pipes are often used in systems where they are subjected to a default bend irrespectively of whether the flexible pipe is applied in a stationary application or a dynamic application. A default bend of a flexible pipe is herein used to designate a bend of the pipe which it is subjected to when it is in unloaded state, i.e. it is not subjected to any forces from internal pressure, hydrostatic pressure or forces supplied by waves and water streams. A default bend is for example a bend provided by a connection of the flexible pipe, in an angle different from the axial angle of the pipe, an intermediate pipe section where a riser is configured to have a “lazy S” or “Steep S” configuration and/or a section or an end of a pipe where it in other ways is configured to have a rest bend which will be practically stationary in unloaded conditions.

The bend limiter of the invention has a length extending between a first end and a second end and a hollow bore along its length. The hollow bore is defined by a surrounding bend limiter wall. The hollow bore has a centre line along the length of the bend limiter.

The bend limiter of the invention has been provided to support a flexible pipe in a default bend configuration. By this construction the risk of overbending has surprisingly shown to be very low or even reduced compared to prior art solutions. Furthermore the durability of the bend limiter has shown to be highly increased because the bend limiter is not subjected to as much stress as a prior art bend limiter would have been if used to support a flexible pipe in a default bend configuration.

The invention further provides new possibility to design the bend limiter with desired bend limiting properties in various directions for example with very restricting bend limiting properties against bends in one direction and less restricting bend limiting properties against bends in another e.g. opposite direction.

In the bend limiter of the invention the centre line of the hollow bore when the bend limiter is in an unloaded condition is a curved centre line or the centre line of the bore when the bend limiter is in an unloaded condition is a straight centre line and the bend limiter wall is at most two fold rotational symmetrical around the straight centre line, preferably at most one fold rotational symmetrical around the straight centre line.

The feature that the centre line of the hollow bore is a curved centre line when the bend limiter is in an unloaded condition should be taken to mean that the centre line of the hollow bore cannot be straight without subjecting the bend limiter to load, i.e. in an unloaded condition the centre of the hollow bore must be a curved centre line when the bend limiter is in an unloaded condition.

A full rotational symmetry is an object that has a symmetry axis where any degree of rotation will provide the object to look the same and with the same mechanical properties, i.e. you cannot see that it has been subjected to a rotation. In this invention bolts, clamps and similar equipment which have no function for the bend limiting properties of the bend limiter are ignored for the assessment of rotational symmetry. An object with a full rotational symmetry can also be said to have infinity-fold rotational symmetry.

A bend limiter has m-fold rotational symmetry if it is identical upon a 360 degree rotation at m points (except for bolts, clamps and similar equipment which have no function for the bend limiting properties of the bend limiter).

In an embodiment of the invention the bend limiter has at most two-fold rotational symmetry around the straight centre line. This means that it has either one-fold rotational symmetry or two-fold rotational symmetry around the straight centre line, but not higher fold of rotational symmetry around the straight centre line.

In a preferred embodiment the bend limiter has at most one-fold rotational symmetry around the straight centre line. This embodiment has shown to provide a very stable bend limiter which in certain applications—in particular when mounted on a flexible pipe subjected to a default bend—has a long durability compared to prior art bend limiters.

The bend limiter may be constructed to be mounted on the flexible pipe prior to application of end-fitting(s) to the flexible pipe or it may be constructed to be mounted on the flexible pipe after mounting of end fitting(s) e.g. as described in U.S. Pat. No. 6,220,303 or GB 2 040 014.

In an embodiment of the invention the bend limiter is a bend stiffener.

In an embodiment of the invention the bend limiter is a bend restrictor.

The terms “bend stiffener” and “bend restrictors” are used herein with the definition according to the above identified API publications API 17B and API 17J.

In an embodiment of the invention, the bend limiter is integrated with an end-fitting and the bend limiter and the end-fitting are mounted simultaneously.

The bend limiter can be mounted to or on the flexible pipe by clamping or by other methods which will be available to the skilled person.

In an embodiment of the invention the centre line of the hollow bore when the bend limiter is in an unloaded condition is a curved centre line with at least one centre line section with a bending radius of about 30 m or less, such as of about 25 m or less, such as of about 20 m or less, such as of about 15 m or less, such as about 10 m or less. The bending radius of the curved centre should preferably be selected in consideration of the flexible pipe and optional default bend(s) of the flexible pipe onto which the bend limiter is to be mounted.

The flexible pipe may be produced to have a default bend, i.e. an unloaded condition where it default will bend to the mentioned default bend. In such situation it is desired that the default bend of the bend limiter is adapted to and preferably has a bend angle similar or identical to the mean or average bend radius of the bend of the flexible pipe as it is to be applied in use.

When selecting a bend radius of the default bend of the bend limiter, the MBR of the flexible pipe should normally be considered while simultaneously considering the bend restricting degree or degrees in various bend directions of the bend limiter.

A bend limiter with a very small bend radius should preferably be used for mounting on a highly flexible pipe or in an embodiment the flexible pipe is produced with a default bend.

Where the centre line of the hollow bore is a curved centre line when the bend limiter is in an unloaded condition, the bend limiter preferably comprises at least one centre line section with a bending radius of from about 0.5 m to about 30 m, such as from about 1 m to about 25 m. Most often the bend radius of the centre line section will be from about 2 m to about 15 m.

In an embodiment of the invention the bend limiter is shaped such that when the bend limiter is in an unloaded condition the centre line of the hollow bore is a curved centre line and the bending radius of the curved centre line varies along the length of the bend limiter. It may for example vary continuously along a part of or the whole of the length of the bend limiter e.g. from about 1 m to about 25 m, such as from about 2 m to about 15 m.

In an embodiment of the invention the bending radius of the curved centre line closer to the first end or closer to the second end of the bend limiter has a larger bending radius than the bending radius of a mid section of the curved centre line at a distance from both the first end and the second end of the bend limiter.

Based on the teaching herein the skilled person will be able to adapt and optimize the bend limiting properties to a specific flexible pipe system.

In an embodiment of the invention the bend limiter is shaped such that when the bend limiter is in an unloaded condition the centre line of the hollow bore is a curved centre line, the bending radius of the curved centre line is substantially identical along the length of the bend limiter.

The term “substantially” should herein be taken to mean that ordinary product variances and tolerances are comprised.

In an embodiment of the invention the bend limiter is shaped such that when the bend limiter is in an unloaded condition the centre line of the hollow bore is a curved centre line and the curved centre line is curved in a curving plan such that tangent to the curved centre line in the curving plan at the first end of the bend limiter has a bend angle to tangent to the curved centre line in the curving plan at the second end of the bend limiter, where the bend angle is between about 175 and about 90 degrees, such as between 150 and 100 degrees.

The term that the centre line is curved in a curving plan means that the centre line in the curved part of the bend limiter is lying in the curving plane. In an embodiment the bend limiter is twisted such that the centre line is not curved in a single curving plan.

In an embodiment of the invention the bend limiter is shaped such that when the bend limiter is in an unloaded condition the centre line of the hollow bore is a curved centre line and the curved centre line is curved such that tangent to the curved centre line at the first end of the bend limiter has a bend angle to tangent to the curved centre line at the second end of the bend limiter, where the bend angle is between about 175 and about 90 degrees, such as between 150 and 100 degrees. In this embodiment the bend limiter may or may not be twisted.

In an embodiment of the invention the bend limiter is shaped such that when the bend limiter is in an unloaded condition the centre line of the hollow bore is a curved centre line, the bend limiter is constructed such that the bend limiter cannot be straightened out such that the centre line becomes straight without thereby damaging the bend limiter wall of the bend limiter.

In an embodiment of the invention the bend limiter is shaped such that when the bend limiter is in an unloaded condition the centre line of the hollow bore is a curved centre line, the bend limiter is constructed such that if the bend limiter wall of the bend limiter is straightened out such that the centre line becomes straight, the bend limiter will be at most one fold rotational symmetrical around the straight centre line in at least a length section of the bend limiter. The at most one fold rotational symmetry around the straight centre line will be caused by at least a variation of tension in the bend limiter wall surrounding the hollow bore.

In an embodiment of the invention the bend limiter is shaped such that when the bend limiter is in an unloaded condition the centre line of the hollow bore is a straight centre line and the bend limiter wall is substantially two fold rotational symmetrical around the straight centre line in at least a length section of the straight centre line.

In an embodiment of the invention the bend limiter is shaped such that when the bend limiter is in an unloaded condition the centre line of the hollow bore is a straight centre line and the bend limiter wall is at most one fold rotational symmetrical around the straight centre line in at least a length section of the straight centre line.

In an embodiment of the invention the bend limiter wall is at most two fold rotational symmetrical around the straight centre line in at least a length section of the straight centre line.

The bend limiter may be provided by any type of materials, preferably suitable for offshore use. The material(s) should be selected to have a sufficient strength and resistance towards corrosion. The material(s) may for example be selected among materials usually used for bend limiters.

The bend limiter may for example be a bend restrictor and comprise a plurality of interconnected rings which together form a set of articulated vertebrae e.g. as described in section 4.4.4 of the API 17J identified above, but with the difference that the set of articulated vertebrae has at most two-fold rotational symmetry around its centre line when held in a straight position, and preferably the set of articulated vertebrae is constructed such that it can bend more in one or two directions than in any other directions. This can for example be achieved by providing that the interconnection between the respective rings of the set of articulated vertebrae are at most two fold rotational symmetrical, e.g. by providing one or a plurality of obstacles in or adjacent to the interconnections to provide that the set of articulated vertebrae can bend more in one direction than in another.

In an embodiment of the invention, the bend limiter is a bend restrictor and comprise a plurality of interconnected rings which together form a set of articulated vertebrae e.g. as described in section 4.4.4 of the API 17J identified above, but with the difference that one or more of the rings forming the set of articulated vertebrae have a wall length in the direction of the bend limiter which differs along the ring-shape of the ring and thereby provides that the set of articulated vertebrae has most two-fold rotational symmetry around its centre line when held in a straight position or provides that the centre line of the set of articulated vertebrae cannot be held in a straight position.

In an embodiment of the invention, the wall of the bend limiter consists essentially of or comprises polymer, such as elastomeric polymers, for example poly urethane (PU), polyethylene (PE), polypropylene (PP), polyvinylchloride (PVC) or mixtures thereof. The polymers may be with or without filler. In an embodiment of the invention the polymer comprises fibre reinforcements. A preferred polymer is PU.

The bend limiter may be manufactured such that the polymer is formed to have a default bend and/or the bend limiter may be manufactured to have an at most two-fold rotational symmetry by varying the thickness of the bend limiter wall.

In an embodiment of the invention, the wall of the bend limiter consists essentially of polymer with embedded wires and/or plates of metal, where the wires and/or plates of metal are embedded to provide the bend limiter wall with at most two fold rotational symmetry with respect to bending stiffness from an unloaded condition.

In an embodiment of the invention, the bend limiter comprises a plurality of cylindrical clamps which are interconnected with a plurality of spring rods, such as described in WO 2006/033597, but with the difference that the spring rods are selected to have a different spring rod strength, a different length or a different distance to adjacent spring rod(s) in the circumference of the bend limiter, to thereby provide the bend limiter with an at most two-fold rotational symmetry.

In a preferred embodiment the bend limiter wall is at most two fold rotational symmetrical with respect to bending stiffness from an unloaded condition.

In a preferred embodiment the bend limiter wall is at most two fold rotational symmetrical with respect to wall thickness of the bend limiter wall.

In a preferred embodiment the bend limiter wall is at most two fold rotational symmetrical with respect to the material or materials providing the bend limiter wall.

In an embodiment the bend limiter comprises voids. The voids may e.g. be provided by providing the bend limiter in a material or a combination of materials comprising a foamed polymer. Alternatively the voids can be provided by other methods, e.g. by extruding a polymer and forming the voids during extrusion and/or casting and/or by making the voids—e.g. a cutting instrument after the bend limiter has been pre-shaped.

The term “voids” designates true voids or fluid filled voids, such as voids filled with liquid, fluid or a combination of liquid or fluid.

In an embodiment the voids are closed voids. In a preferred embodiment at least a part by volume, such as about 50% by volume or more is open voids. More preferably the voids are open such that water can flow into the voids when the bend limiter is submerged in sea water.

In an embodiment when the bend limiter is in an unloaded condition the total volume of voids preferably is varying in the circumference of the bend limiter in at least a length section thereof.

In an embodiment where the bend limiter wall comprises voids, the bend limiter wall is at most two fold rotational symmetrical with respect to the bending stiffness at least partly due to the voids.

By applying the voids to regulate the stiffness of the bend limiter a very simple method of producing the bend limiter is provided.

In an embodiment the bend limiter wall comprises elongate voids, wherein the main amount of voids by volume in an unloaded condition is arranged with an elongate length direction substantially following the centre line.

Such elongate voids can in a simple way be produced upon extrusion of the bend limiter.

In an embodiment the bend limiter wall comprises voids provided by holes in the bend limiter wall extending from an outer surface to an inner surface of the bend limiter wall. Such holes can be provided by perforating the bend limiter wall after it has been pre-shaped. These perforations can be provided in any size(s, form(s) and configurations (pattern and concentration). Thereby it is very simple to design and produce the bend limiter with a desired stiffness and/or with an at most two fold rotational symmetry.

In an embodiment of the invention, the stiffness from an unloaded condition of the bend limiter in at least one bending direction varies along the length of the bend limiter, preferably the stiffness of the bend limiter decreases from the first end and in a distance of at least about 80%, preferably at least about 90% of the length of the bend limiter towards the second end of the bend limiter.

In an embodiment of the invention, the stiffness from an unloaded condition of the bend limiter in at least one bending direction is substantially identical along the length of the bend limiter.

The skilled person will understand that the above embodiments can be combined.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

All features of the inventions including ranges and preferred ranges can be combined in various ways within the scope of the invention, unless there are specific reasons not to combine such features.

### BRIEF DESCRIPTION OF DRAWINGS

The invention will be explained more fully below in connection with a preferred embodiment and with reference to the drawings in which:

FIG. 1a shows a sectional side view of a bend limiter of the invention which has a default bend.

FIG. 1b shows a sectional side view of a variation of the bend limiter of FIG. 1a with a default bend and with a variation in thickness of the bend limiter wall in the circumference of the bend limiter.

FIG. 2 shows a sectional side view of a bend limiter of the invention which has a one-fold rotational symmetry due to metal wires embedded in the bend limiter wall.

FIG. 3a shows a side view of a bend limiter of the invention which has a one-fold rotational symmetry due to a plurality of elongate voids in the bend limiter wall.

FIG. 3b shows a cross-sectional view seen in line C-C′ of FIG. 3a.

FIG. 4a shows a side view of a bend limiter of the invention which has a one-fold rotational symmetry due to a plurality of voids provided by perforations of the bend limiter wall.

FIG. 4b shows a first example of cross-sectional view seen in line D-D′ of FIG. 4a.

FIG. 4c shows a second example of cross-sectional view seen in line D-D′ of FIG. 4a.

FIG. 5a shows a sectional side view of a bend limiter of the invention which has a one-fold rotational symmetry in an unloaded condition due to variation in thickness of the bend limiter wall.

FIG. 5b shows a cross-sectional view seen in line A-A′ of FIG. 5a.

FIG. 5c shows a cross-sectional view seen in line B-B′ of FIG. 5a.

FIG. 6a shows a sectional side view of a bend limiter of the invention which comprises a plurality of interconnected rings which together form a set of articulated vertebrae where the set of articulated vertebrae has a one-fold rotational symmetry in straight and unloaded condition due to the shape of the individual rings of the set of articulated vertebrae.

FIG. 6b shows an individual ring of the bend limiter of FIG. 6a.

FIG. 7 shows a sectional side view of another bend limiter provided by interconnected rings forming a set of articulated vertebrae where the set of articulated vertebrae has a one-fold rotational symmetry in straight and unloaded condition due to the shape of the individual rings of the set of articulated vertebrae.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

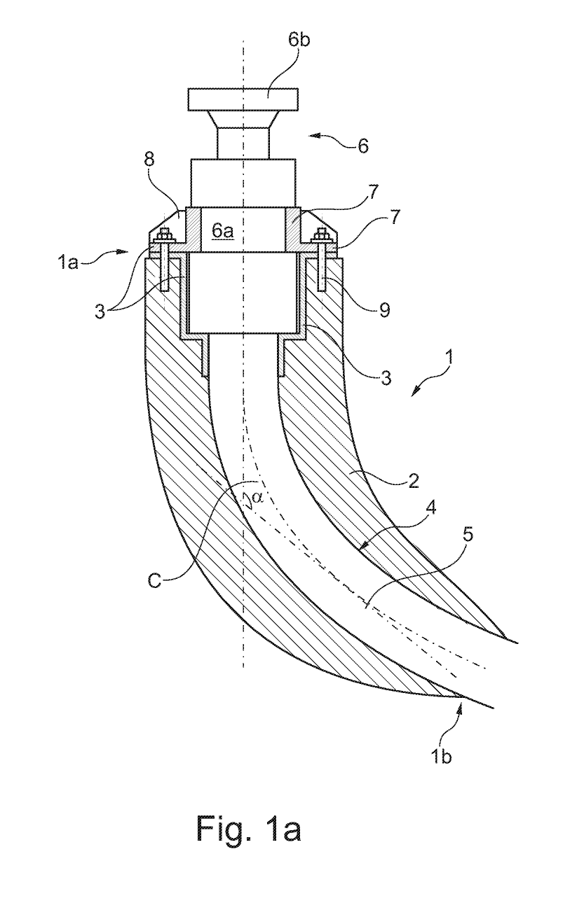

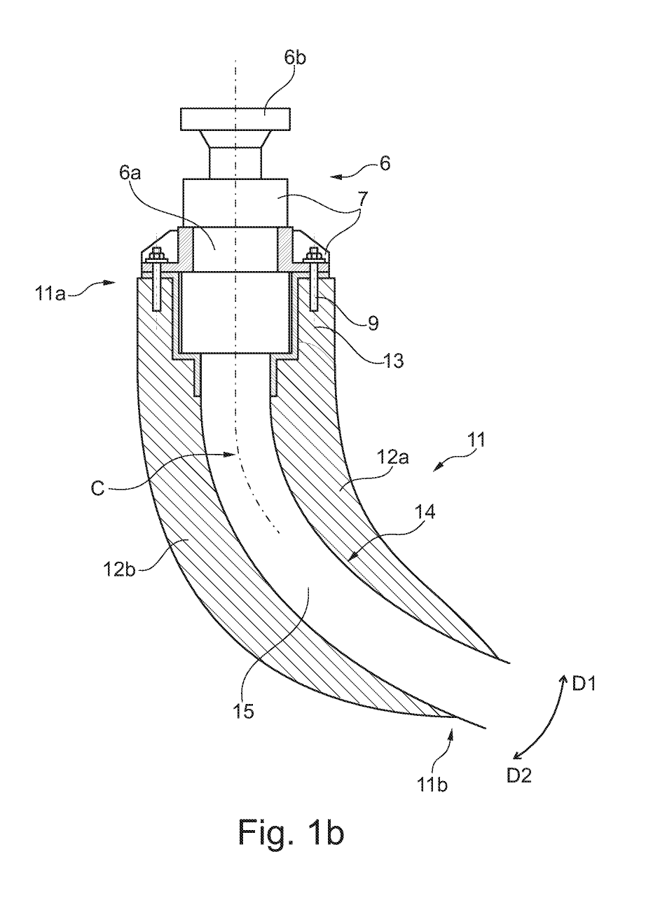

The bend limiter 1 of FIG. 1a has a length extending between a first end 1a and a second end 1b and a hollow bore 4 along its length, the hollow bore is defined by a surrounding bend limiter wall 2. The hollow bore 4 has a centre line C along the length of the bend limiter 1. The bend limiter 1 further comprises a mounting flange 3. Such mounting flanges are well known by a skilled person and will usually be provided in a strong material such as steel. The bend limiter 1 is connected to a mounting flange 7 of a mounting ring 8 by a plurality of bolts. In the present example the mounting ring 8 is integrated with an end fitting 6 comprising an end fitting body 6a in which a pipe 5 is mounted and a connecting flange 6b for connecting the pipe to e.g. a platform, another pipe, a tank or similar.

It should be understood that the bend limiter 1 could have been mounted on a flexible pipe in a distance from such end fitting e.g. by use of a mounting clamp.

The bend limiter 1 of FIG. 1a is in an unloaded condition and it can be seen that tangent to the curved centre line at the first end 1a of the bend limiter has a bend angle a to tangent to the curved centre line at the second end 1b of the bend limiter, where α is about 130 degrees.

The bend limiter 11 of FIG. 1b has a length extending between a first end 11a and a second end 11b and a hollow bore 14 along its length, the hollow bore is defined by a surrounding bend limiter wall 12a, 12b. The hollow bore 14 has a centre line C along the length of the bend limiter 11. The bend limiter 11 further comprises a mounting flange 13. The bend limiter 11 is connected to a mounting flange 7 of a mounting ring 8 as shown and described in FIG. 1a.

The bend limiter 11 is in an unloaded condition and is bent as the bend limiter shown in FIG. 1a.

The bend limiter wall 12a, 12b has a variation in thickness of the bend limiter wall 12a, 12b in the circumference thereof. As seen the thickness of the bend limiter wall 12a, 12b is larger in one side of the bend limiter wall 12b than in an opposite side of the bend limiter wall 12a, thereby the bend limiter 11 is provided with relatively high restricting bend limiting properties against bends in the direction D1 and less restricting bend limiting properties against bends in the opposite direction D2. By this way it is now possible to design the bend limiter with desired bend limiting properties in various directions to avoid over bending the pipe and/or to reduce the risk of colliding with other submerged parts, such as other pipes or parts of pipe structures and/or reefs or similar, while simultaneously maintaining a desired flexibility of the flexible pipe.

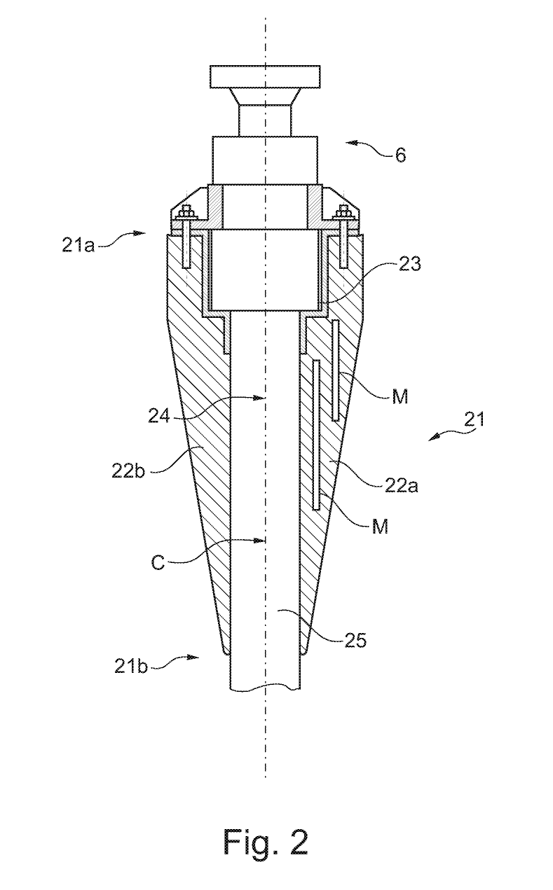

The bend limiter 21 of FIG. 2 has a length extending between a first end 21a and a second end 21b and a hollow bore 24 along its length, the hollow bore is defined by a surrounding bend limiter wall 22a, 22b. The hollow bore 24 has a centre line C along the length of the bend limiter 21. The bend limiter 21 further comprises a mounting flange 23. The bend limiter 21 is connected to a mounting flange 7 of a mounting ring 8 as shown and described in FIG. 1a and such that a pipe 25 is provided in the bore 24 of the bend limiter 21.

The bend limiter 21 is in an unloaded condition and has a straight centre line C. The bend limiter 21 of the invention which has a one-fold rotational symmetry due to metal wires M embedded in one side of the bend limiter wall 22a. Thereby the one side of the bend limiter wall 22a has a higher stiffness than the opposite side of the bend limiter wall 22b. In the shown embodiment the bend limiter 21 comprises two metal wires M embedded in the bend limiter wall 22a. In another not shown version the bend limiter could comprise three, four or more metal wires and/or stiffening plates or similar stiffening element embedded in its wall.

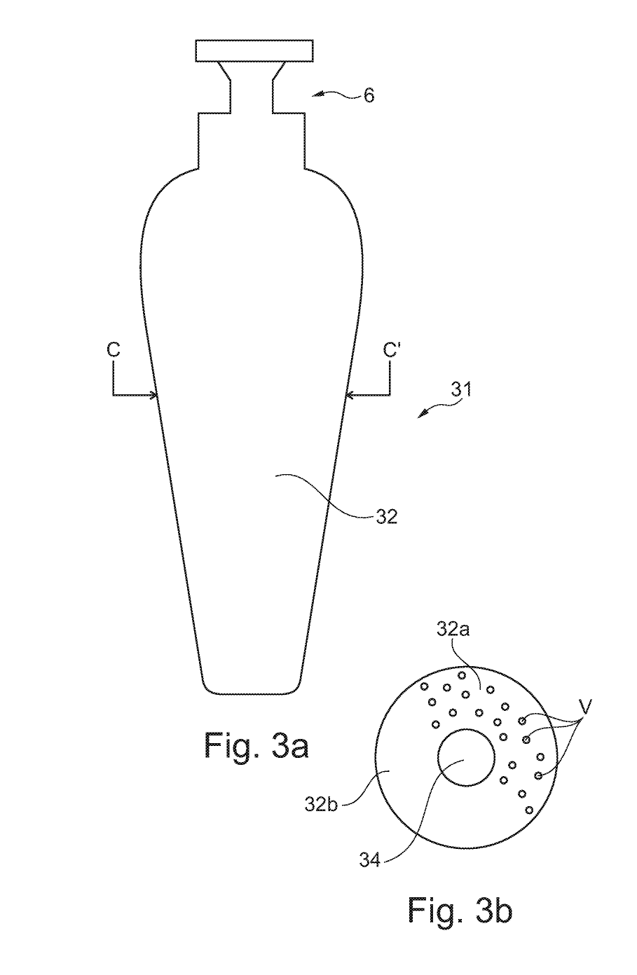

The bend limiter 31 of FIGS. 3a and 3b has a length, a bend limiter wall 32, 32a, 32b and a hollow bore 34 along its length. The hollow bore 34 is defined by the surrounding bend limiter wall 32, 32a, 32b. The hollow bore 34 has a centre line along the length of the bend limiter 31. The bend limiter 31 further comprises a not shown mounting flange connected to a fitting 6 e.g. similar as shown in FIG. 1.

The bend limiter 31 is in an unloaded condition and has a straight centre line. The bend limiter 31 of the invention which has a one-fold rotational symmetry due to voids V in the bend limiter wall 32, 32a, 32b. As seen the voids V are arranged only in one side of the bend limiter wall 32a, whereas the other side of the bend limiter wall 32b is fee of voids.

In a not shown variation thereof voids are distributed in the whole circumference of the bend limiter wall but such that the voids in one side of the bend limiter wall provide a stiffness which is different from the stiffness provided by voids in another side of the bend limiter wall—e.g. by providing more or larger voids in one side than in another side of the bend limiter wall.

The voids V are elongate voids, preferably extending in most or all of the length of the bend limiter 31. The voids V are preferably open such that sea water can flow through the voids V when the bend limiter 31 is submerged in sea water.

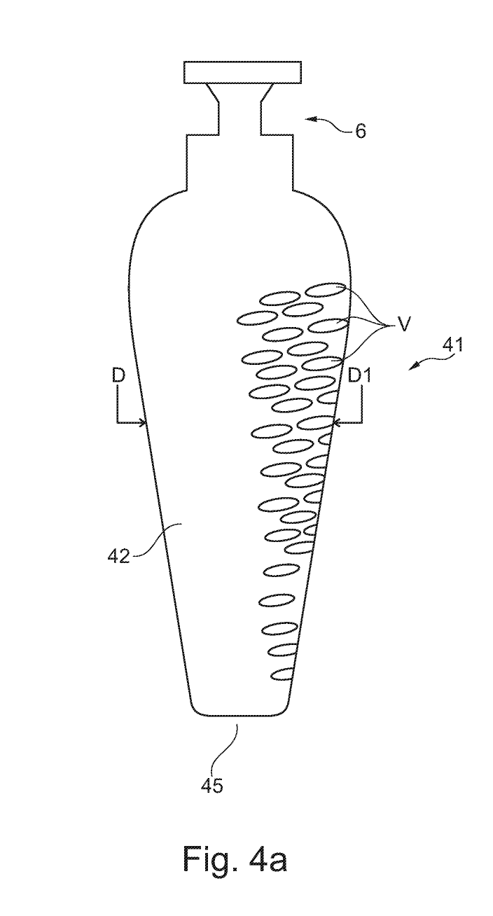

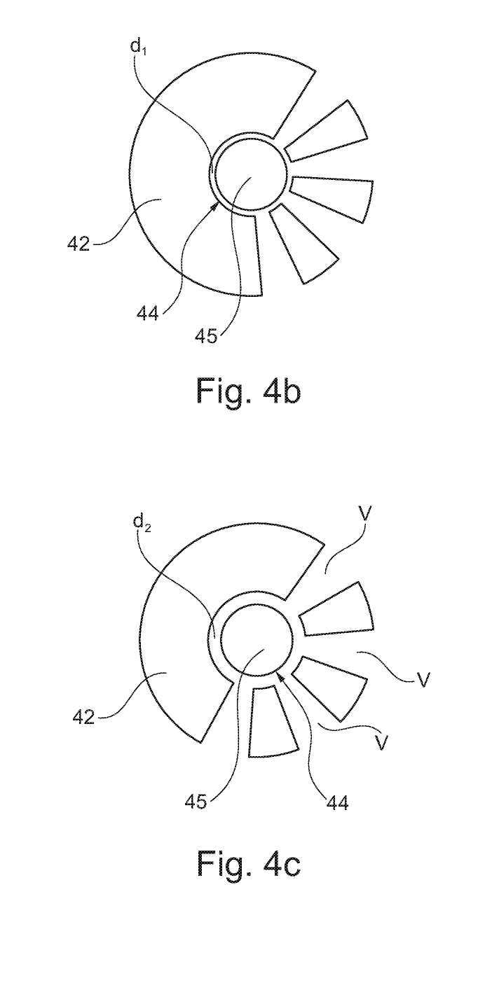

The bend limiter 41 of FIGS. 4a, 4b and 4c has a length, a bend limiter wall 42, and a hollow bore 44 along its length. The hollow bore 44 is defined by the surrounding bend limiter wall 42. The hollow bore 44 has a centre line along the length of the bend limiter 41. The bend limiter 41 further comprises a not shown mounting flange connected to a fitting 6, e.g. similar as shown in FIG. 1, and such that a pipe 45 is provided in the bore 44 of the bend limiter 41.

The bend limiter 41 is in an unloaded condition and has a straight centre line. The bend limiter 41 of the invention which has a one-fold rotational symmetry due to voids V in the bend limiter wall 44. As seen the voids V are arranged only in one side of the bend limiter wall but as explained for the embodiment in FIGS. 3a and 3b the voids could in a variation have a different distribution, while still providing an at most two-fold rotational symmetry due to the voids.

The voids V are provided by holes in the bend limiter wall provided by perforating the bend limiter wall 42. The voids are oval with a largest diameter substantially perpendicular to the centre line.

In the first example of cross-sectional view seen in line D-D′ of FIG. 4a, the flexible pipe 45 has an outer periphery such that the distance d1 between the pipe 45 and inner side of wall 42 is relatively small or there is no distance at all, i.e. the bend limiter 41 is tightly fitting around the pipe or even fixed directly to the pipe.

In the second example of cross-sectional view seen in line D-D′ of FIG. 4a, the flexible pipe 45 has an outer periphery such that the distance d2 between the pipe 45 and the inner side of wall 42 is sufficiently large to allow water to pass around the pipe and optionally cool the pipe if desired.

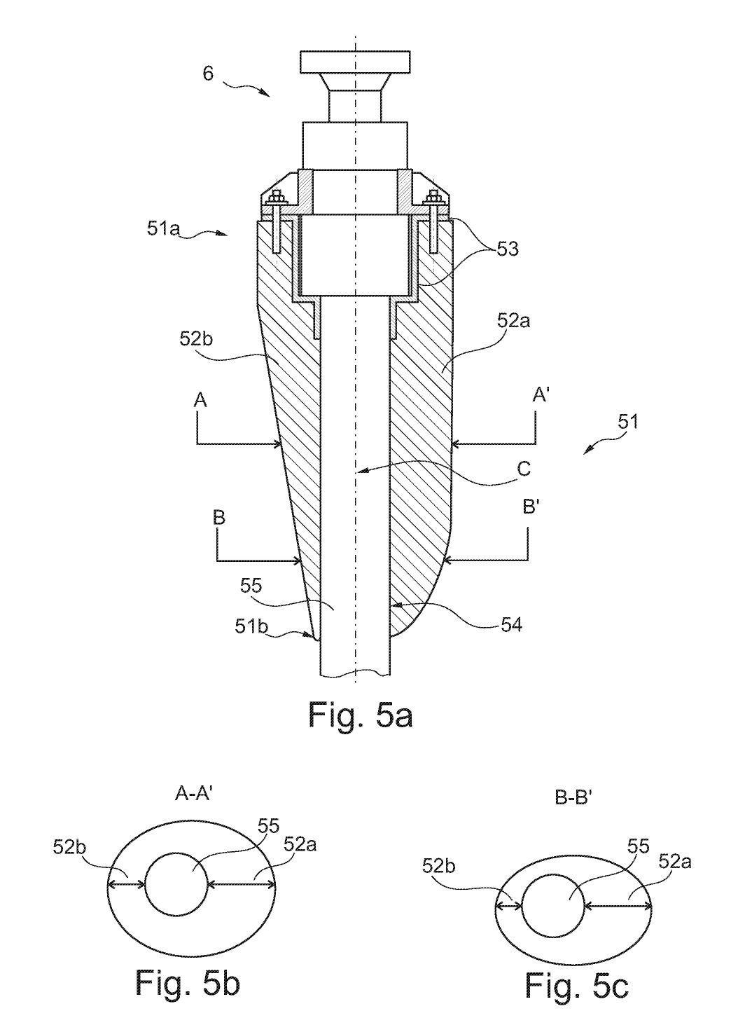

The bend limiter 51 of FIGS. 5a, 5b and 5c has a length extending between a first end 51a and a second end 51b and a hollow bore 54 along its length, the hollow bore is defined by a surrounding bend limiter wall 52a, 52b. The hollow bore 54 has a centre line C along the length of the bend limiter 51.

The bend limiter 51 further comprises a mounting flange 53. The bend limiter 51 is connected to an end fitting 6, e.g. similar as shown in FIG. 1, and such that a pipe 55 is provided in the bore 54 of the bend limiter 51.

The bend limiter 51 is in an unloaded condition and has a straight centre line. The bend limiter 51 of the invention which has a one-fold rotational symmetry due to variation in thickness of the bend limiter wall 52a, 52b.

As seen the thickness of the bend limiter wall 52a, 52b is larger in one side of the bend limiter wall 52b than in an opposite side of the bend limiter wall 52a, thereby the bend limiter 51 is provided with relatively high restricting bend limiting properties against bends in one direction and less restricting bend limiting properties against bends in the opposite direction. Simultaneously the thickness of the bend limiter wall 52a, 52b gradually decreases in thickness.

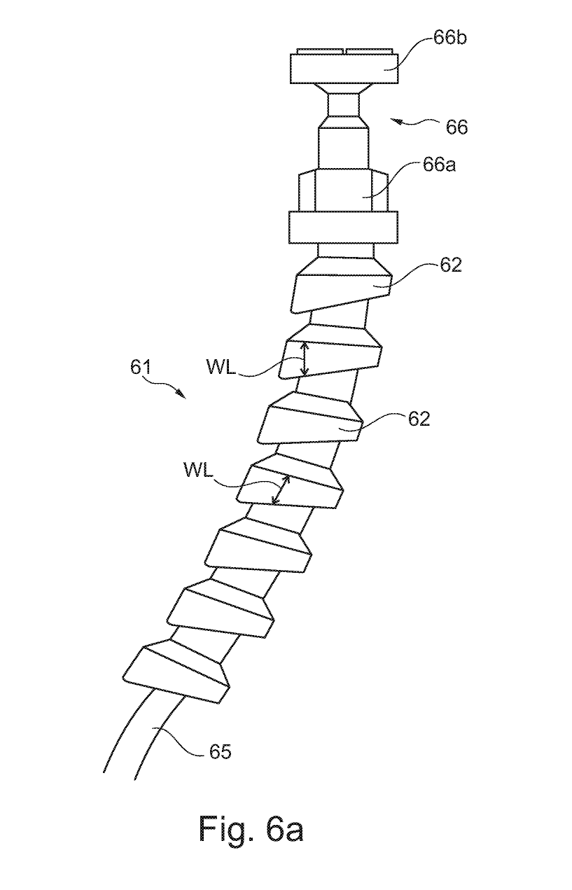

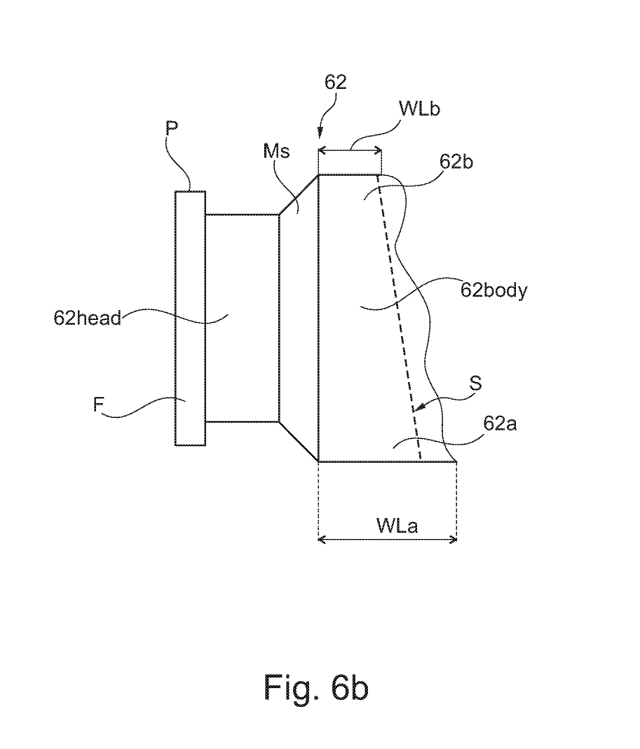

The bend limiter 61 shown in FIG. 6 is of the bend restrictor type and comprises a plurality of interconnected rings 62 which together form a set of articulated vertebrae. In the present embodiment the set of articulated vertebrae is mounted on a flexible pipe 65 connected to an end fitting 66 comprising an end fitting body 66a in which a pipe 65 is mounted and a connecting flange 66b for connecting the pipe to e.g. a platform, another pipe, a tank or similar. In a variation the bend limiter 66 could have been mounted directly on the pipe 65 in a distance from the end fitting 66 e.g. by use of one or more clamps.

The rings 62 of the bend limiter 61 has a wall length WL in the length direction of the bend limiter which differs along the circumference of the ring-shape of the ring 62 and thereby provides that the set of articulated vertebrae has at most two-fold rotational symmetry around its centre line when held in a straight position.

In FIG. 6b an individual ring 62 of the bend limiter 61 is shown. The ring 62 comprises a body 62 body and a head 62 head interconnected by a mid-section Ms. The head 62 head comprises a flange F. The flange F of one ring 62 is adapted to be connected by insertion into the body 62 body of another ring 62. As shown the flange F comprises a protrusion. This protrusion is arranged to engage with a not shown groove in the inner side of the body 62 body to ensure that the ring 62 is maintained in its circumferential position. The inner side of the body 62 body further comprises a stop flange indicated with the dotted line S, which stop flange ensures that the flange F does not escape from the body 62b once inserted. The flange F can move inside the body 62b from the mid section MS to the stop flange S. The Wall length WL of the body 62 body differs along the circumference of the ring-shape of the ring 62 from a longest length WLa in one side 62a of the wall to a shortest length WLb in the opposite side 62b of the ring-shape of the ring 62.

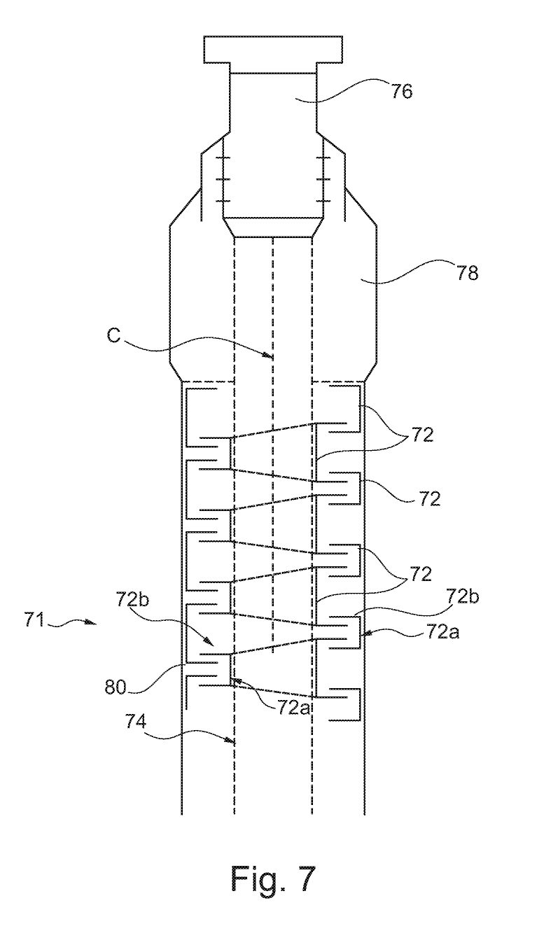

The bend limiter 71 of FIG. 7 is also of the bend restrictor type and comprises a plurality of interconnected rings 72 which together form a set of articulated vertebrae. The interconnected rings 72 are rings with a C shaped profiles with a C mid-part 72a and perpendicular legs 72b. The rings 72 are interconnected by arranging the rings 72 such that every second ring 72 has its legs 72b pointing towards the bore 74 and the other every second ring 72 has its legs 72b pointing away from the bore 74. The length in the direction along the centre line C of the C mid-part 72a of the rings 72 differs along the circumference of the ring-shape of the ring 72 and thereby provides the set of articulated vertebrae with at most two-fold rotational symmetry around its centre line when held in a straight position.

In the present embodiment the set of articulated vertebrae is mounted to a mounting ring 78 which is connected to a connecting flange 76 for connecting the pipe to e.g. a platform, another pipe, a tank or similar.

Some preferred embodiments have been shown in the foregoing, but it should be stressed that the invention is not limited to these, but may be embodied in other ways within the subject-matter defined in the following claims.

What is claimed is:

1-20. (canceled)

21. A bend limiter suitable for protecting an unbonded flexible offshore pipe, the bend limiter has a length extending between a first end and a second end and a hollow bore along its length, the hollow bore is defined by a surrounding bend limiter wall, the hollow bore has a centre line along the length of the bend limiter wherein the centre line of the hollow bore, when the bend limiter is in an unloaded condition, is a curved centre line or wherein the centre line of the bore, when the bend limiter is in an unloaded condition, is a straight centre line and the bend limiter wall is at most two fold rotational symmetrical around the straight centre line.

22. The bend limiter as claimed in claim 21, wherein the centre line of the hollow bore, when the bend limiter is in an unloaded condition, is a curved centre line with at least one centre line section with a bending radius of about 30 m or less.

23. The bend limiter as claimed in claim 21, wherein the centre line of the hollow bore, when the bend limiter is in an unloaded condition, is a curved centre line with at least one centre line section with a bending radius of from about 0.5 m to about 30 m.

24. The bend limiter as claimed in claim 21, wherein the centre line of the hollow bore, when the bend limiter is in an unloaded condition, is a curved centre line wherein the bending radius of the curved centre line varies along the length of the bend limiter.

25. The bend limiter as claimed in claim 21, wherein the centre line of the hollow bore, when the bend limiter is in an unloaded condition, is a curved centre line wherein the bending radius of the curved centre line is substantially identical along the length of the bend limiter.

26. The bend limiter as claimed in claim 21, wherein the centre line of the hollow bore, when the bend limiter is in an unloaded condition, is a curved centre line where the curved centre line is curved such that tangent to the curved centre line at the first end of the bend limiter has a bend angle to tangent to the curved centre line at the second end of the bend limiter, where the bend angle is between about 175 and about 90 degrees.

27. The bend limiter as claimed in claim 21, wherein the centre line of the hollow bore, when the bend limiter is in an unloaded condition, is a curved centre line wherein the bend limiter wall if the bend limiter is straightened out such that the centre line becomes straight will be at most one fold rotational symmetrical around the straight centre line in at least a length section of the bend limiter, the at most one fold rotational symmetry around the straight centre line will be caused by at least a variation of tension in the bend limiter wall surrounding the hollow bore.

28. The bend limiter as claimed in claim 21, wherein the centre line of the hollow bore, when the bend limiter is in an unloaded condition, is a straight centre line wherein the bend limiter wall is substantially two fold rotational symmetrical around the straight centre line in at least a length section of the straight centre line.

29. The bend limiter as claimed in claim 21, wherein the centre line of the hollow bore, when the bend limiter is in an unloaded condition, is a straight centre line wherein the bend limiter wall is at most one fold rotational symmetrical around the straight centre line in at least a length section of the straight centre line.

30. The bend limiter as claimed in claim 28, wherein the bend limiter wall is at most two fold rotational symmetrical around the straight centre line in at least a length section of the straight centre line.

31. The bend limiter as claimed in claim 21, wherein the bend limiter wall is at most two fold rotational symmetrical with respect to bending stiffness from an unloaded condition.

32. The bend limiter as claimed in claim 21, wherein the bend limiter wall is at most two fold rotational symmetrical with respect to wall thickness of the bend limiter wall.

33. The bend limiter as claimed in claim 21, wherein the bend limiter wall is at most two fold rotational symmetrical with respect to the material or materials providing the bend limiter wall.

34. The bend limiter as claimed in claim 21, wherein the bend limiter wall comprises voids, wherein the total volume of voids, when the bend limiter is in an unloaded condition is varying in the circumference of the bend limiter in at least a length section thereof.

35. The bend limiter as claimed in claim 21, wherein the bend limiter wall comprises voids, and the bend limiter wall is at most two fold rotational symmetrical with respect to the bending stiffness at least partly due to the voids.

36. The bend limiter as claimed in claim 21, wherein the bend limiter wall comprises elongate voids, wherein the main amount of voids by volume in an unloaded condition is arranged with an elongate length direction substantially following the centre line.

37. The bend limiter as claimed in claim 21, wherein the bend limiter wall comprises voids which are open to allow water to enter the voids when submerged under water.

38. The bend limiter as claimed in claim 21, wherein the bend limiter wall comprises voids provided by holes in the bend limiter wall extending from an outer surface to an inner surface of the bend limiter wall.

39. The bend limiter as claimed in claim 21, wherein the stiffness from an unloaded condition of the bend limiter in at least one bending direction varies along the length of the bend limiter, preferably the stiffness of the bend limiter decreases from the first end and in a distance of at least about 80% of the length of the bend limiter towards the second end of the bend limiter.

40. The bend limiter as claimed in claim 21, wherein the stiffness from an unloaded condition of the bend limiter in at least one bending direction, is substantially identical along the length of the bend limiter.

41. The bend limiter as claimed in claim 24, wherein the bending radius of the curved centre line closer to the first end or closer to the second end of the bend limiter has a larger bending radius than the bending radius of a mid section of the curved centre line at a distance from both the first end and the second end of the bend limiter.

42. An unbonded flexible offshore pipe, the pipe comprising a protecting bend limiter, the bend limiter has a length extending between a first end and a second end and a hollow bore along its length, the hollow bore is defined by a surrounding bend limiter wall, the hollow bore has a centre line along the length of the bend limiter wherein the centre line of the hollow bore, when the bend limiter is in an unloaded condition, is a curved centre line or wherein the centre line of the bore, when the bend limiter is in an unloaded condition, is a straight centre line and the bend limiter wall is at most two fold rotational symmetrical around the straight centre line.
